(19) United States
(12) Patent Application Publication
(10) Pub. No.: US 2016/0127804 A1
(43) Pub. Date: May 5, 2016

(54) VISUAL ADVERTISING AND EMERGENCY ALERT SYSTEM

(71) Applicants: Joseph Raymond Wilson, Brentwood, TN (US); Michael DiMartinis, Sicklerville, NJ (US); Nicholas DiMartinis, Sicklerville, NJ (US)

(72) Inventors: Joseph Raymond Wilson, Brentwood, TN (US); Michael DiMartinis, Sicklerville, NJ (US); Nicholas DiMartinis, Sicklerville, NJ (US)

(21) Appl. No.: 14/930,520

(22) Filed: Nov. 2, 2015

Related U.S. Application Data
(60) Provisional application No. 62/073,698, filed on Oct. 31, 2014.

(51) Int. Cl. H04N 21/81; H04N 21/234

(52) U.S. Cl. CPC H04N 21/814; H04N 21/812; H04N 21/23424

(57) ABSTRACT

A system and method for visual advertising and emergency alerting via a plurality of display screens is provided. The system includes a computing device, a plurality of area monitoring systems, at least one interconnection controller, and a high-speed network. The high-speed network is adapted to connect the computing device with the plurality of display screens and the plurality of area monitoring systems via the interconnection controller. The system is configured to enable a plurality of transmission signal sources to be routed to any desired destination while maintaining the ability to be overridden by an emergency message.

### FIELD OF THE DISCLOSURE

The field of the present invention relates to visual advertising and emergency alerting system. More specifically, the present invention relates to a single comprehensive information management system that provides emergency message override capability over a scheduled visual advertising content as displaying on a plurality of display screens.

### BACKGROUND OF THE DISCLOSURE

Information management in public areas is a very important concept with regard to maintaining the smooth operation of the public area. The public areas such as airports, seaports, bus stations etc. utilize various different types of information management systems such as televisions, billboards, and/or speakers. All these systems are adapted for broadcasting various different types of information such as public advertising, visual paging, and flight directory.

Further, these information management systems as utilized in various public places use their own signal network for transmitting the various signals to and from the said information management systems. The public advertisement system uses its own hardware as well as software module to be integrated with each other for transmitting various advertisement signals. Similarly, the flight directory uses its own hardware as well as software module to be integrated with each other for transmitting various signals of flight timings, the airport terminal, and/or the seating plan.

Accordingly, every public place has several information management systems having its own information transporting system as well as broadcasting system. Thus every information management system requires its own network wiring and its own hardware, own software as well as the special team for its operation. Thus the overall costing of installation, operation, and maintenance of all these information management systems goes very high.

However, in the event of emergency the above said systems are rendered useless and special emergency alerting systems providing the emergency alert messages are considered more useful. Eventually, there came up security systems that used the advertising platforms for alerting people. However, these security systems still require constant people monitoring. Further, these security systems also require human intervention for generating emergency alert messages to be publically conveyed. All these

Moreover, in the fateful moments, it becomes highly relevant to broadcast the highest priority emergency alert messages such as evacuation plans or the safety measures to the affected public. It becomes highly crucial to guide people during these situations and provide the most updated and precise information to the affected public.

Moreover, the existing emergency alerting systems create more havoc than informing and guiding the affected public during an emergency situation. Usually such havocs are created due to broadcasting the emergency alert messages on all the display devices present in a particular public area. This would unnecessary create panic in an area which is unlikely to be affected by the adversity.

Therefore, an intelligent system that can identify a particular emergency and act upon the alerting mechanism in a way that does not create chaos in the areas which won't be affected by the emergency is indispensable.

The present systems involve the factor of human error and their inefficiency to utilize the advertising systems in the event of emergency. Hence, a system for advertising is required that also functions as emergency alert systems.

Furthermore, all the information management system as placed in the public places does not have any facility to coordinate with each other during such adverse conditions.

Therefore, an intelligent system is required which can help in coordinating all these information management systems in a situation of emergency.

Further, an intelligent system is also required which can minimize the human interface for managing a public place.

Therefore, a single information management system is required which can enable multiple information sources to be routed to any destination via one signal transmission line. The said system is adapted to convey different advertisement information to the public while maintaining the ability of overriding the said advertisement information by an emergency alert message.

Further, a system is required which can reduce the cost and problems of maintaining multiple information management systems with one comprehensive information management system that provides emergency override capability while adding value to producing a revenue stream and in addition saving the money on maintaining multiple systems.

### SUMMARY OF THE DISCLOSURE

In view of the foregoing disadvantages inherent in the prior-art and the needs as mentioned above, the general purpose of the present disclosure is to provide a system and method of visual advertising as well as emergency alerting, to include all advantages of the prior art and to overcome the drawbacks inherent in the prior art offering some added advantages.

To achieve the above objectives and to fulfill the identified needs, in one aspect, the present invention aims to provide one comprehensive visual advertising system that provides emergency message override capability over a scheduled advertising content.

Further, the present invention solves the problem of maintaining multiple information management systems with one comprehensive information management system. Further, the system and method as proposed by the present invention are capable to reduce the human interface.

In an aspect of the present invention, the present system and method enables all the security systems to interface with a single transport system thus enabling multiple information sources to be routed to any destination while maintaining the ability of to be overriding the advertisement information by an emergency alert message.

In another aspect of the present invention, the multiple information managing systems of a populous place are replaced with a single information managing system which effectively manages all the advertisement information and also provide a well coordination of providing emergency alert message only on a desired location where the alter message is more required.

In an aspect the present invention provides a system for visual advertising and emergency alerting via a plurality of display screens. The said system includes at least one computing device, a plurality of area monitoring systems, at least one interconnection controller, and a high-speed network.

The said high-speed network is adapted for connecting the said computing device with the said plurality of display screens and the said plurality of area monitoring systems via the said interconnection controller. The said computing device includes data storage, at least one processor, and at least one software module. The said data storage is adapted to be uploaded with a digital content. The said digital content is selected from at least one of a video content, an audio content, a written content, or a visual graphic content. The said processor is adapted to provide a schedule the said digital content. The said software module is adapted for running the said scheduled digital content over the said polarity of display screens. Hence, the said computing device acts as a server.

Further, the plurality of area monitoring systems as provided herein are adapted for monitoring and recording an audio video profile of a particular area of a public place. The said software module is adapted to run the said scheduled content as well as the said audio video profile of a particular area over the said plurality of display screens via the said interconnection controller and the said high-speed network. Accordingly, the present system provides an easy means of running an advertisement as well as the real time monitoring of the public area over a plurality of display screens.

The interconnection controller is in communication with the said computing device, the said operation center or a fire command center, and/or the plurality of display screens. The said interconnection controller provides a signal routing facility to the said plurality of display screens.

Further, the interconnection controller as provided herein includes a signal encoder adapted for coding a plurality of transmission signals received from the said computing device, the said operation center or a fire command center, and/or the said plurality of area monitoring systems. The interconnection controller further includes a signal decoder adapted for decoding a plurality of said transmission signals.

In an emergency situation, the interconnection controller receives an emergency command from the said operation center or the fire command center and the encoder generates a code corresponding to the said emergency command. Further, the said code is transmitted to the said software module present on the computing device. The software module interprets the said code and sends a transmission signal code to the said interconnection controller. Further, the said signal decoder reads the said transmission signal and decodes the said transmission signal code into a visual alert message. The said visual alert message is transmitted to the said plurality of display screens.

In case the code is related to a particular emergency alert message to be displayed on a particular public area then the said software module override the said running of the scheduled content in that particular public area with running an emergency content arising from an operation center or a fire command center.

Accordingly, the present invention provides a system and method where a plurality of transmission signal sources are routed to any desired destination while maintaining the ability of overriding a visual advertisement by an emergency message.

In yet another aspect, the present invention provides a visual advertising and alert system that can identify a particular emergency situation and provide an emergency alert message in a particular public area. Thus the present system does not create chaos in other areas which are not affected by the particular emergency situation.

It is an object of the present invention to provide a system and method that reduces the human interface of continuous monitoring a public area. Hence, the present system avoids the factor of human error in monitoring the public area.

It is yet another object of the present invention to provide a system and method which effectively utilizes the advertising systems in the event of emergency situation.

In yet another aspect, the present invention provides an information management system having one signal transporting medium such as a high speed internet connection. It is an object of the present invention to provide an intelligent system that reduces the overall cost of installing, operating and managing a public information system in a crowded place such as a railway terminal, an airport terminal and/or a bus terminal.

In yet another aspect, the present invention provides a well-coordinated information management system which can handle various types of public advertisements. Further, the said system is capable to override the public advertisements in a particular public area with running an emergency alert message arising from an operation center or a fire command center

In yet another aspect, the present invention provides a single information management system which can enable multiple information sources to be routed to any destination via one signal transmission line. The said system is adapted to convey different advertisement information to the public while maintaining the ability of overriding the said advertisement information by an emergency alert message.

This together with the other aspects of the present invention along with the various features of novelty that characterized the present disclosure is pointed out with particularity in claims annexed hereto and forms a part of the present invention. For better understanding of the present disclosure, its operating advantages, and the specified objective attained by its uses, reference should be made to the accompanying descriptive matter in which there are illustrated exemplary embodiments of the present invention.

### BRIEF DESCRIPTION OF THE DRAWINGS

The advantages and features of the present disclosure will become better understood with reference to the following detailed description and claims taken in conjunction with the accompanying drawing, in which:

FIG. 1 illustrates a block diagram of advertising and alerting system, according to various embodiments of the present invention;

FIG. 2 illustrates a flow chart of the method for advertising and alerting system, according to various embodiments of the present invention;

FIG. 3 is a schematic view of an embodiment of the present invention;

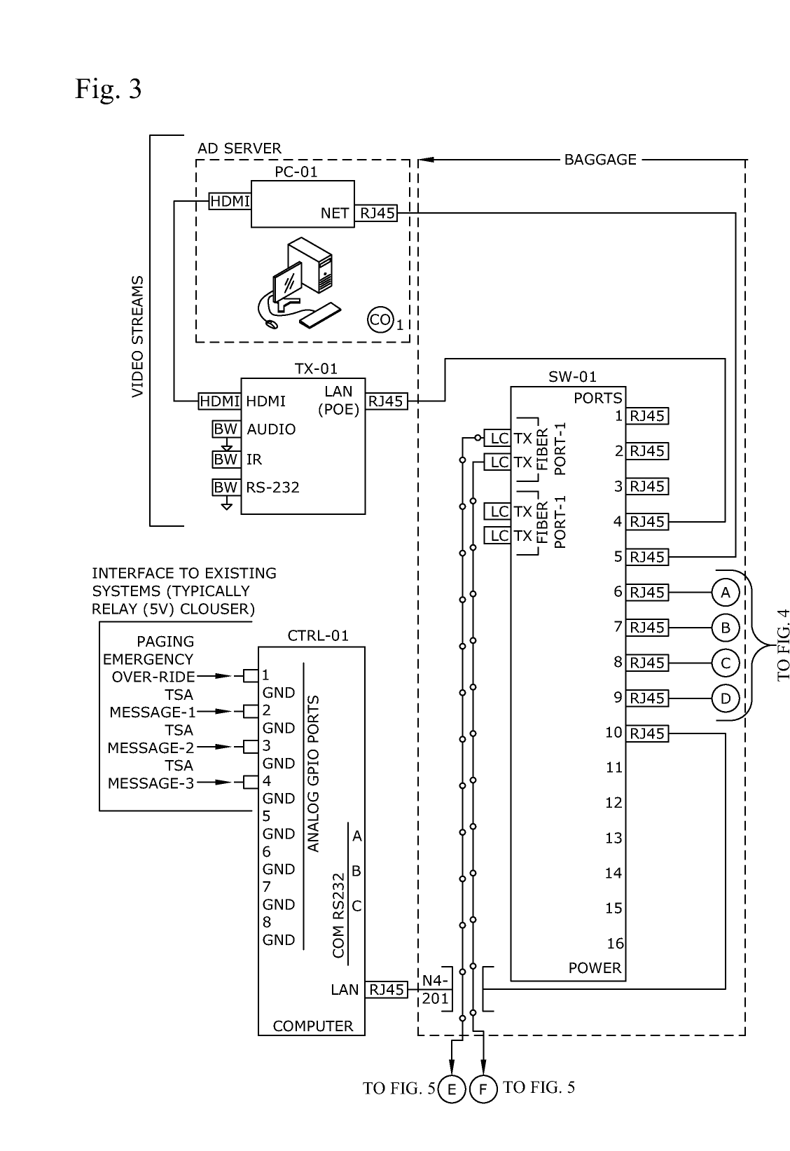

FIG. 4 is a continuation of FIG. 3;

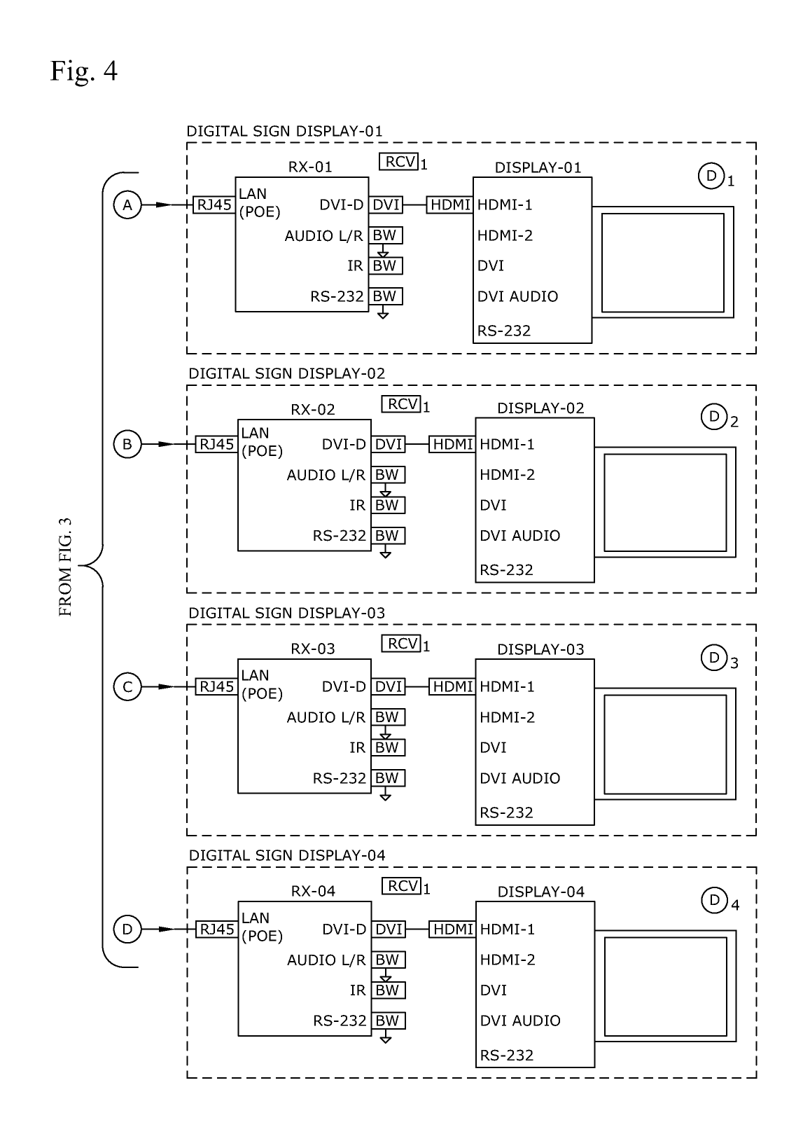

FIG. 5 is a continuation of FIG. 3;

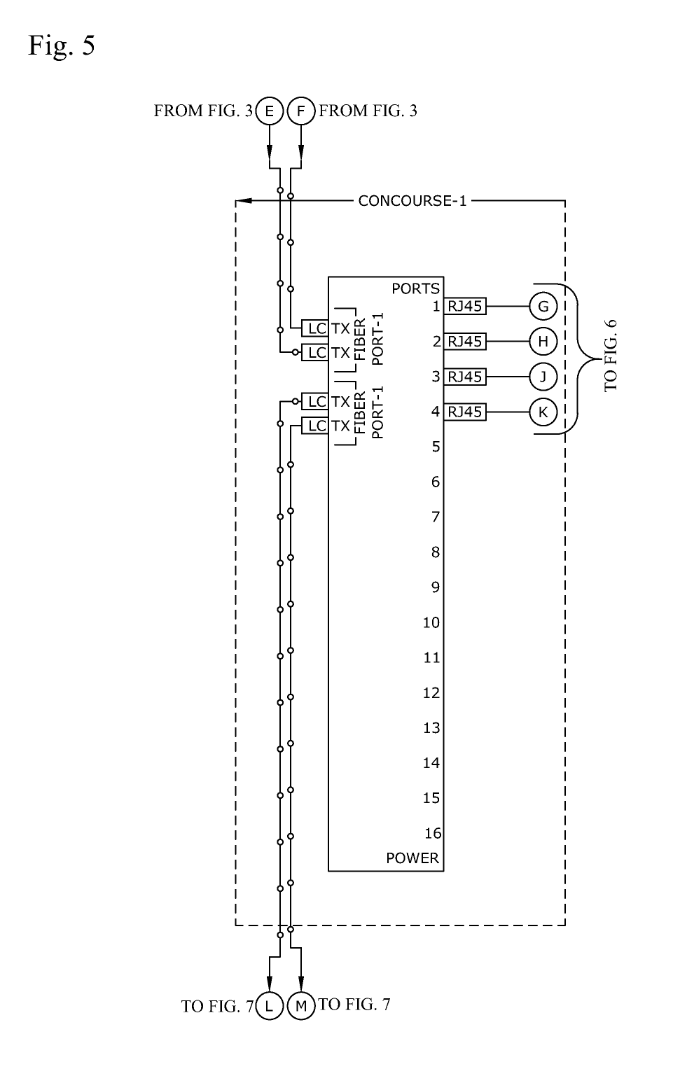

FIG. 6 is a continuation of FIG. 5;

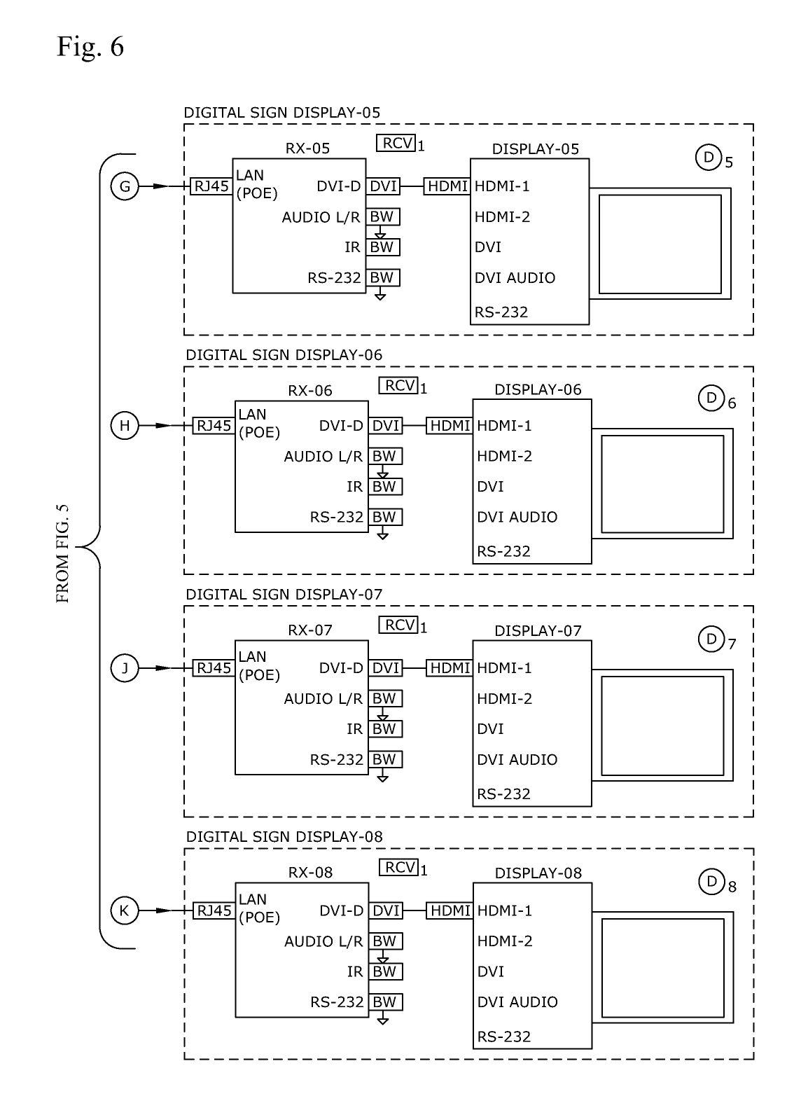

FIG. 7 is a continuation of FIG. 5;

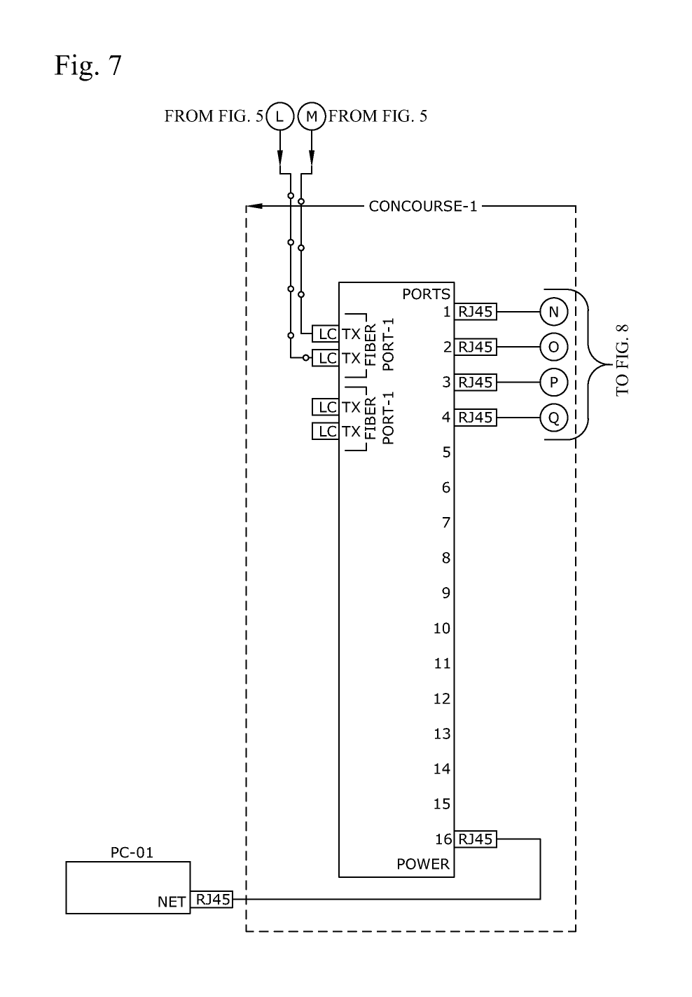

FIG. 8 is a continuation of FIG. 7; and

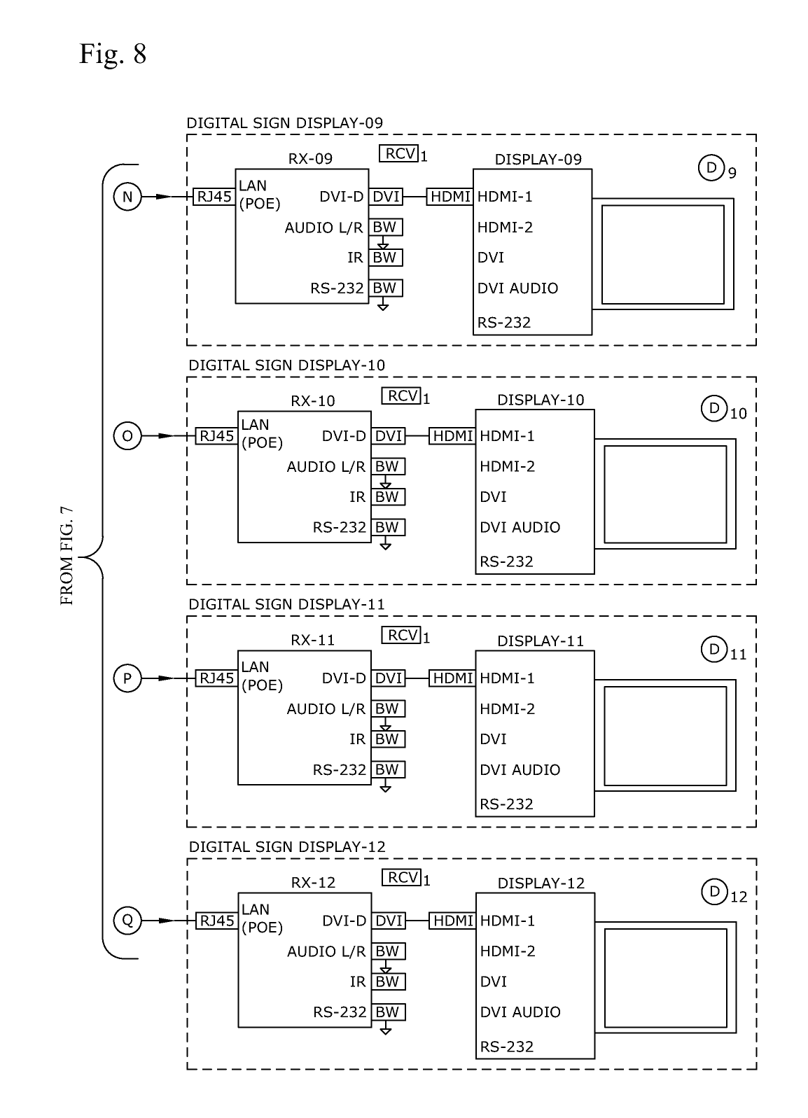

FIG. 9 is a flow chart illustrating an embodiment of the security system of the present invention.

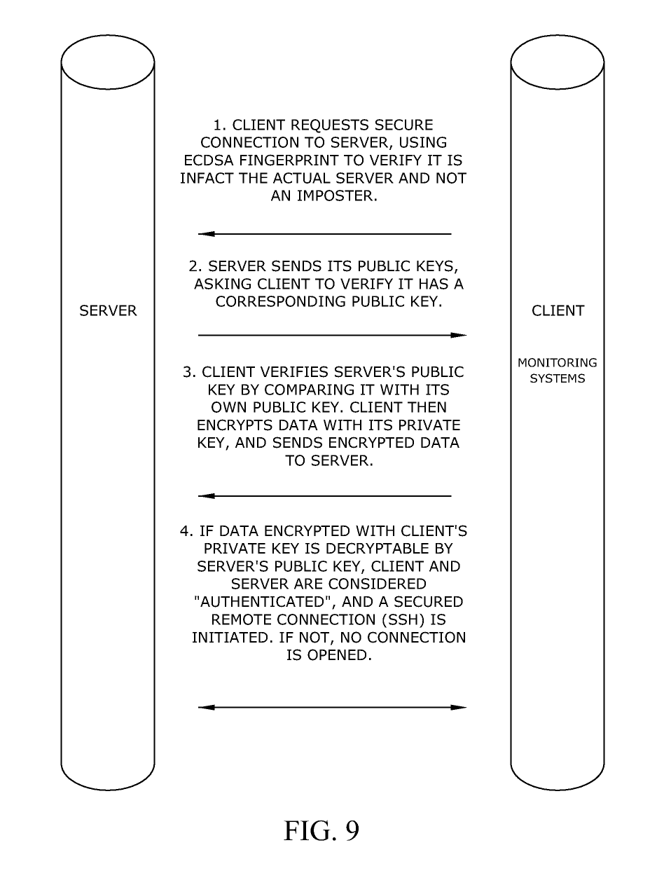

Like numerals refer to like elements throughout the present disclosure.

### DETAILED DESCRIPTION OF THE DISCLOSURE

The foregoing descriptions of specific embodiments of the present disclosure have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

The terms “a” and “an” herein do not denote a limitation of quantity, but rather denote the presence of at least one of the referenced item.

The term “broadcasting devices” refers to a medium for broadcasting multimedia, graphic messages, text advertisement and/or text messages to at least an individual. Broadcasting devices include, but not limited to display screens, speakers and/or a combination thereof.

The term “computing device” or “server” are used interchangeably herein and refer to a processor enabled device connected with a network.

The term “network” relates to a junction whose major function is to communicate the signal from area monitoring system and convey it to the server. Additionally, the network is used as a passage of advertisement and/or emergency feed from the server to the interconnection controller.

The term “interconnection controller” is network device used as encoder and/or decoder. Further, the interconnection controller transmits the broadcast from the server to a plurality of broadcasting devices.

The present invention includes an interface that converts external stimulus to provide emergency overrides of HD full motion video feeds with an electronic communication security system. The present invention includes software and hardware that interface with Fire Alarm and Public Address Systems at Airports and other locations and converts external stimulus regardless of type (button, switch, inferred, etc.) to provide emergency overrides of HD full motion video feeds alerting the public of the type of emergency and any available additional information such as location of the emergency and direction to safety exits. The software can interface with single or multiple HD Visual Streaming Monitor Systems. The present invention may include no delays to any visual HD Monitor System's advertising/news/sports/informational content and may immediately allow content to resume once the emergency override has been shut-off.

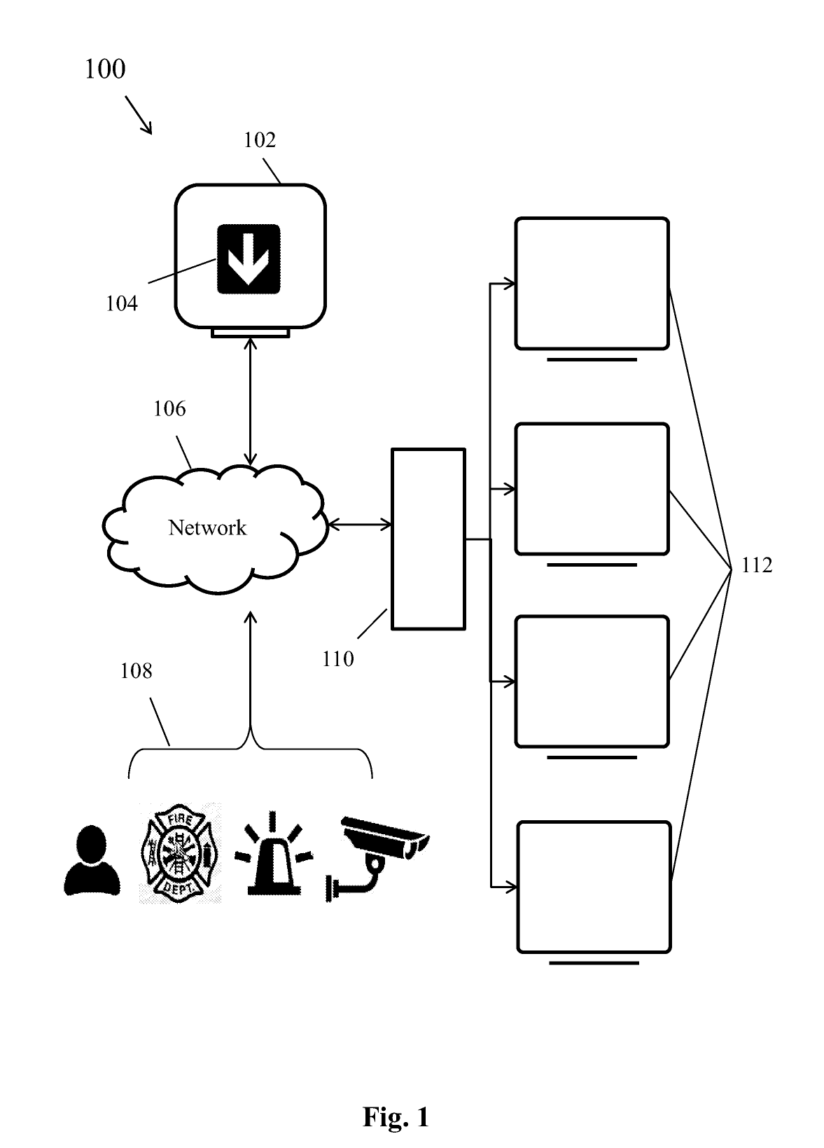

According to an embodiment of the present invention, the system for advertisement and emergency alerting 100 is illustrated in FIG. 1. In FIG. 1, the server 102 has a software module 104 installed thereon which broadcast the digital content via a network 106. The said digital content is broadcasted on the plurality of broadcasting devices 112. In an exemplary embodiment, the system 100 is set up at an airport. The server 102 has space for data storage wherein the digital content for broadcast is stored.

The digital content refers to any type of digital content that is stored in either digital or analog storage like the data storage of the server 102. More specifically, the digital content includes but not limited to audio, video, text content as required for broadcasting or advertisement. In an embodiment, there is a plurality of digital contents stored on the data storage of the server 102. The software module 104 and a processor (not shown) of the server 102 decides or schedules a particular digital content. The said content scheduling can be both automatic or manually by user.

Here, the system 100 at an airport, as illustrated in FIG. 1 includes the network 106 coupled with the server 102 and the interconnect controller 110. The network is a high speed internet connection that runs throughout the system 100. Additionally, the network 106 is connected to the internet, authorized users such as airport authority, fire department, video surveillance, emergency alerting systems etc. Basically, the network 106 has communication with almost all departments of the airport, public as well as security systems.

The interconnect controller 110 encodes and/or decodes the signal as well as broadcast sent by network 106. Accordingly, the broadcast is then sent to particular broadcasting devices 112, like a display screen and is broadcasted on the said device.

In various embodiments of the present invention, an advertisement is selected as a digital content by the software module 104. The selection is either by automatically (an algorithm) and/or by an authorized user. The selected advertisement is then fetched from the data storage of the server 102 and transmitted to the interconnect controller 110 via the network 106.

In yet an embodiment, an advertisement or video or audio, or text or a combination thereof is downloaded from the internet and transmitted to interconnect controller 110. Once the interconnect controller 110 receives such advertisement, it is encoded to be played on a particular display screen 112 of the airport. Such broadcast is then transmitted via high speed lines of the network 106 to the particular device 112.

Accordingly, the broadcast is displayed over the particular broadcasting device 112 for which it is intended. And the intended broadcasting device 112 broadcasts the said advertisement. In various embodiments, the said advertisement is broadcasted on all available broadcasting devices 112 of the airport. In another scenario, the broadcast is selected by the software module 104 based on the location or environment or people's choice or a combination thereof. Hence, there could be different broadcasts running on different screens simultaneously. Like, boarding lounge in the airport has a different advertisement than the area viewed at the gate.

In an embodiment, the software module selects different advertisements based on the particular area of the airport. Say, the people waiting in the boarding lounge are broadcasted with advertisements related to a particular country for which their flight(s) is/are intended. Further, the people are shown advertisements related to “to-visit places”, “nearest cab/hotels” etc. or advertisements related to most relevant places, services a user needs after a user gets off of the flight.

The advertisements displayed in the boarding lounge are different in context than those displayed at the gates. Like, at the entry/exit gates advertisements related to cab services, nearest hotels, ways to embassy etc. are displayed.

In various aspects of the present invention, the advertising and emergency alerting system 100 as illustrated in FIG. 1 displays emergency alerting messages at the broadcasting devices 112. In the event of an emergency the commercial advertisements or other advertisement information displayed on the broadcasting devices 112 are overridden by an emergency alert message or emergency visual content. Like, in the event of fire, the broadcasting devices 112 such as digital screen, speakers etc. would broadcast the emergency alert message as selected by the server 102.

In an embodiment, the software module 104 of the server 102 decides which among the different emergency alert messages is to be broadcasted in a particular emergency situation. For example, the message selected is as precise as possible, giving all necessary details, providing further information like “prevention” or “evacuation” details, along with ensuring that no or minimum chaos is caused.

In an implementation, the emergency alert message is only broadcasted at places/locations which are most likely to be affected by the emergency. In this way, peace is maintained at various other locations of the airport and it becomes easy to deal with the emergency at hand.

In different embodiments of the present invention, the network is in direct contact/communication with the different public as well as security systems of the airport. For example, an alert raised by the fire department is first communicated to the server 102. Here, the software module 104 receives the alert and identifies the particular area in the airport which is the epicentre of emergency/adversity. The emergency alert messages, evacuation plans, disaster management and other similar information are then identified and notified to that particular area.

In an embodiment, the signals received from sensors such as smoke detectors are received by the said plurality of area monitoring systems. The area monitoring system is a monitoring, surveillance, security system which is in constant contact with the server 102 via the network 106. Say, an area that is a blind spot for video cameras but still has sensors such as smoke detectors like in restrooms. Now since this area has no video surveillance hence it is impossible for existing systems to identify an emergency such as fire. But the present system uses the signals from the smoke detectors to identify the area in question. Then an emergency alert message is broadcasted to such area. Further, people in close proximity to the said area are advised not to visit that area.

Additionally, the alert message in the proximity area is not necessarily related to evacuation. This is done to avoid the stir that would follow if an alert message of fire was broadcasted. The signal detected is first analysed, this is done by the controller 110. The signals are detected and then coded and sent to the server 102. The server analyses the coded signals and identifies if there is an actual threat.

Simultaneously, various concerned departments and/or personnel are alerted of the situation. At this point, the advertising schedule is interrupted and overridden by the alert messages selected by the server 102.

In an embodiment, there are situations where various decisions are taken and improvisations happen. The server 102 is adapted to obey the commands of the authorized users in such cases. Like, if the scheduled evacuation plan and instructions involve people to evacuate from lobby 2 but due to unavoidable circumstances the said lobby cannot be used. In such situations the airport security comes up with another evacuation route and overrides the existing scheduled evacuation plan.

In certain embodiments, the present invention may include a security system. The monitoring systems 108 of the present invention include a plurality of clients. When a client is sending emergency details to the server 102, the client firs requests a secure connection with the server 102. In certain embodiments, the secure connection is requested using elliptic curve digital signature algorithm (ECDSA) fingerprint to verify it is in fact the actual server and not an imposter. The server 102 then sends its public keys asking the client to verify it has a corresponding public key. The client then verifies the server's public key by comparing it with its own public key. The client then encrypts data with its private key, and sends the encrypted data to the server 102. The encrypted data includes the type of the emergency and the command for the broadcasting devices 112 to display. If the data encrypted with client's private key is decryptable by the server's public key, the client and the server are considered authenticated and a secure remote connection is initiated. If not, then no connection is opened. The above security system is implemented to prevent outside parties from hacking into the system and delivering an unwanted emergency display.

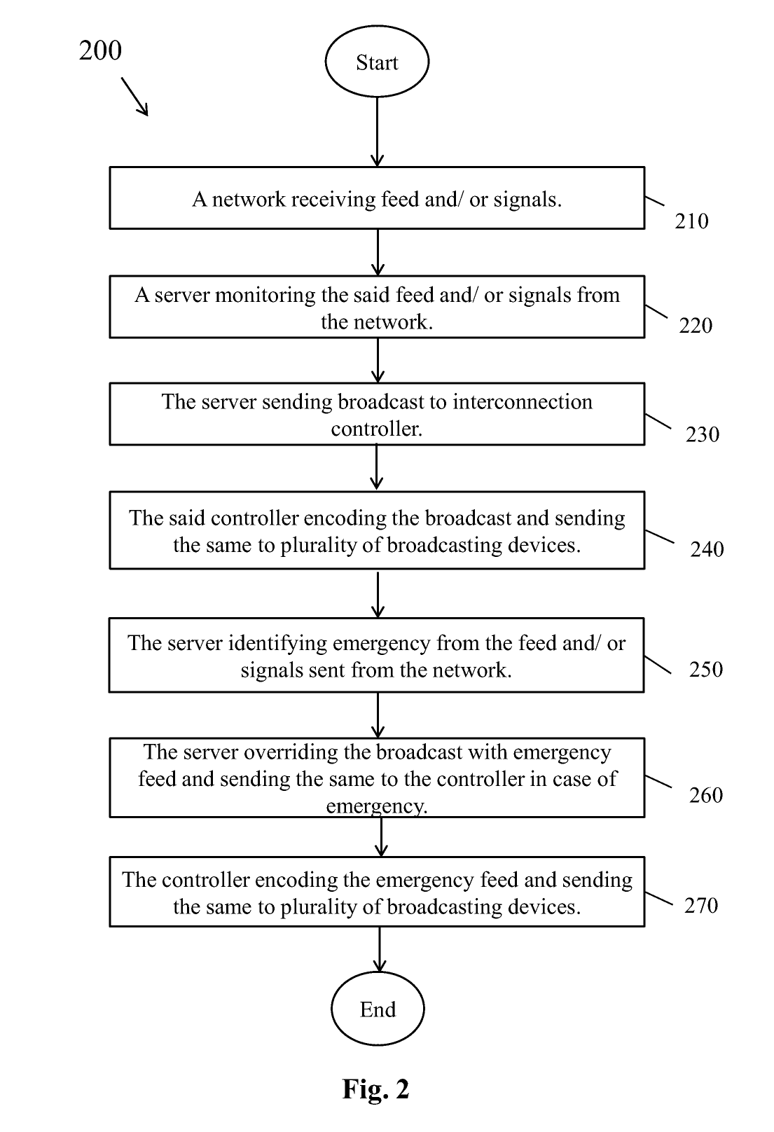

According to an embodiment of the present invention, FIG. 2 illustrates the flow chart of the method 200 for advertising and emergency alerting. The method 200 starts at 210 wherein a network that is in constant contact with the monitoring system 108 of FIG. 1. The feed from the network is constantly analysed by the server at step 220.

Meanwhile, the software module installed on the server schedules the digital content to be broadcasted by the broadcasting devices to people. A particular digital content or broadcast is then fetched from the data storage of the server and sent to interconnection controller at step 230.

At step 240, the controller encodes the broadcast for a particular display device. This is done to customize the advertisement for various areas of public spaces like airport, bus stops etc.

Simultaneously, the monitoring system that is providing the surveillance such as public spaces like airport constantly provides feedback to the server. Say, the monitoring system reports an emergency, like in step 250. The system as is in constant communication with the server, the server determines the kind of emergency and various protocols and instructions to be followed.

Accordingly, at step 260, the server overrides the advertisements with emergency messages and protocols. This information is then sent to the interconnect controller via the network. The said controller also receives information regarding the display screens which need to display the alert message.

At step 270, the controller encodes the alert message for the particular display(s) and transmits the said emergency alert message to a particular broadcasting device 112.

The following is an exemplary implantation of the system and method described above. The present invention may accept stimulus from a 48 volt, 24 volt, 12, volt, 5 volt direct current, and the like. In certain embodiments, 5-Volt Direct Current (VDC) is injected into a de-energized Audio Sensing Relay(s) (ASR) via a low amperage 5-VDC power supply. When an audio signal is sensed by the relay, the relay energizes, which sends the 5-VDC into a Buck Converter which converts the 5-VDC signal into a 3.3-VDC signal, which is then sensed by a General Purpose Input/output on the Single Board Computer (SBC) equipped with a 10K pull down resistor. When the signal is sensed by the GPIO, (depending on which GPIO senses the signal) a BASH Script is launched which sends commands to the remote Dedicated Monitor(s) System (DMS). For Security, each time a BASH Script is initiated to change a DMS displayed information, a 4096 bit Pre-Shared RSA key may be implemented. This RSA key is shared with the SBC devices manually, so as to stop and prevent any new unauthorized devices that may find their way on the network from receiving possible sensitive content.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

What is claimed is:

1. A system for visual advertising and emergency alerting via a plurality of display screens, the system comprising:
at least one computing device having at least one software module, wherein the computing device acts as a server;
a plurality of area monitoring systems each adapted for monitoring and recording an audio video profile of a particular area;
at least one interconnection controller having a signal encoder adapted for coding a plurality of transmission signals received from the computing device or the plurality of area monitoring systems, and a signal decoder adapted for decoding a plurality of the transmission signals; and
a high-speed network connecting the computing device with the plurality of display screens and the plurality of area monitoring systems via the interconnection controller, wherein the system is configured to enable a plurality of transmission signal sources to be routed to any desired destination while maintaining the ability to be overridden by an emergency message.

2. The system as claimed in claim 1, wherein the computing device comprises:
a data storage adapted to be uploaded with a digital content; and
a processor adapted to schedule the digital content, wherein the digital content is selected from at least one of a video content, an audio content, a written content, or a visual graphic content.

3. The system as claimed in claim 2, wherein the software is adapted to run the scheduled content as well as the audio video profile of a particular area over the plurality of display screens via the interconnection controller and the high-speed network.

4. The system as claimed in claim 2, wherein the software module is adapted to override the running of the scheduled content with running an emergency content arising from an operation center or a fire command center.

5. The system as claimed in claim 1, wherein the interconnection controller is in communication with the computing device, the operation center or a fire command center, the plurality of display screens, and wherein the interconnection controller provides a signal routing facility to the plurality of display screens.

6. The system as claimed in claim 5, wherein the interconnection controller receives an emergency command from the operation center or a fire command center and the encoder generates a code corresponding to the emergency command.

7. The system as claimed in claim 6, wherein the code is transmitted to the software module present on the computing device, wherein the software module interprets the code and sends the transmission signal to the interconnection controller.

8. The system as claimed in claim 7, wherein the signal decoder reads the signal code and decodes the signal code into a visual alert message, wherein the visual alert message is transmitted to the plurality of display screens.

9. The system as claimed in claim 1, further comprising an authorized client, wherein the authorized client comprises an authentication of one of the plurality of area monitoring systems by the computing device.

10. The system as claimed in claim 9, wherein the authentication comprises an encryption of an emergency data by a private key of the authorized client sent to the computing device, wherein the emergency data comprises the emergency message, and wherein the computing device decrypts the emergency data using a public key of the computing device.

11. A method for visual advertising and emergency alerting via a plurality of display screens, the method comprising:
connecting at least one computing device to a high-speed network, wherein the computing device comprises a processor, a data storage and at least one software module;
uploading and scheduling a digital content via the computing device;
monitoring and recording an audio video profile of a particular area via a plurality of area monitoring systems;
running the scheduled digital content as well as the audio video profile of a particular area over the plurality of display screens via the software module of the computing device;
overriding the running of the scheduled content with running an emergency content arising from an operation center or a fire command center, wherein the emergency content is routed to a particular display screen via an interconnection controller, wherein the method enables a plurality of transmission signal sources to be routed to any desired destination while maintaining the ability to be overridden by an emergency message.

12. The method as claimed in claim 11, wherein the processor of the computing device is adapted to schedule the digital content, wherein the digital content is selected from at least one of a video content, an audio content, a written content, or a visual graphic content.

13. The method as claimed in claim 11, wherein the software module is adapted to run the scheduled content as well as the audio video profile of a particular area over the plurality of display screens via the interconnection controller and the high-speed network.

14. The method as claimed in claim 11, wherein the software module is adapted to override the running of the scheduled content with running an emergency content arising from an operation center or a fire command center.

15. The method as claimed in claim 11, wherein the interconnection controller comprises a signal encoder adapted for coding a plurality of transmission signals received from the computing device or the plurality of area monitoring systems, and a signal decoder adapted for decoding a plurality of transmission signals.

16. The method as claimed in claim 15, wherein the interconnection controller is in communication with the computing device, the operation center or a fire command center, the plurality of display screens, and provides a signal routing facility to the plurality of display screens.

17. The method as claimed in claim 16, wherein the interconnection controller receives an emergency command from the operation center or a fire command center and the encoder provide a code corresponding to the emergency command.

18. The method as claimed in claim 17, wherein the code is transmitted to the software module present on the computing device, the software module interprets the code and send a transmission signal to the interconnection controller.

19. The method as claimed in claim 18, wherein the signal decoder read the signal code and decode the same into a visual alert message, wherein the visual alert message is transmitted to the plurality of display screens.
